(19) United States
(12) Patent Application Publication
(10) Pub. No.: US 2003/0177261 A1
(43) Pub. Date: Sep. 18, 2003

(54) Storage system, program and method for operating storage system, information processing terminal, program for operating the same, and data management system

(76) Inventors: Takaaki Sekiguchi, Yokohama (JP); Takashi Fukumoto, Sagamihara (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/101,064

(22) Filed: Mar. 20, 2002

(30) Foreign Application Priority Data
Mar. 14, 2002 (JP) 2002-69629

(51) Int. Cl. G06F 15/173

(52) U.S. Cl. 709/238; 709/224

(57) ABSTRACT

A destination-of-movement candidate acquiring unit of a user terminal selects one of a plurality of storage systems, which has a shorter response time. A destination-of-movement candidate adding unit of the user terminal adds, to an access request, destination-of-movement candidate information specifying the selected one storage system. A destination-of-movement candidate managing unit of an origin-of-movement storage system manages frequency of the access request from the user terminal for each candidate for the destination of movement. When the frequency of the access request exceeds a predetermined value, the destination-of-movement candidate managing unit instructs a file system interface to read data and then move the read data to the candidate for the destination-of movement-for which the frequency of the access request has exceeded the predetermined value. As a result, the user terminal is able to access the storage system having a shorter response time.

### FIELD OF THE INVENTION

The present invention relates to a storage system that is connected to one or more other storage systems via a communication network, manages plural kinds of data and receives an access request for the data from an information processing terminal via the communication network, and also relates to a program and a method for operating the storage system. Further, the present invention relates to an information processing terminal, a program for operating the same, and a data management system including the storage system and the information processing terminal.

### DESCRIPTION OF THE RELATED ART

Several techniques regarding conventional storage systems are disclosed in, e.g., Japanese Unexamined Patent Application Publication Nos. 7-200389 and 9-16448. The technique disclosed in the former publication concerns with relocation of data within a storage system based on correlations among a plurality of data files, and the technique disclosed in the latter publication concerns with relocation of data within a storage system based on reference to update records of data files.

Also, Japanese Unexamined Patent Application Publication No. 9-16448 discloses a technique for moving, to another recording medium, data that is not referred to, and Japanese Unexamined Patent Application Publication No. 2001-125820 discloses a technique for compressing or discarding data.

Any of those conventional techniques is intended to improve the performance of a storage system. Specifically, response to data and effective usage of storage areas, within a closed region, i.e., within the storage system or a certain area under management of each system manager.

However, when there arises in future a situation in which storage systems provided by SSP's (Storage Service Providers) are distributed to many districts over a wide-area communication network, such as the Internet, and a very large number of computers, such as mobile terminals, utilize the distributed storage systems, a limitation occurs even with endeavors for improving response to data and effective usage of storage areas within one storage system as intended by the conventional techniques. For example, when trying to access a certain storage system from a remote district via a communication network, a delay occurred in the communication network often makes the user feel slowdown in response even if response within the storage system is improved. Also, even if the effective usage of storage areas is improved within one storage system, there is a limitation on storage capacity of the one storage system. This raises a problem that the user cannot acquire a desired storage capacity in some cases.

In other words, when a plurality of storage systems are distributed over a communication network in future, the conventional techniques will not be satisfactorily adapted for desires of users in many cases.

### SUMMARY OF THE INVENTION

In view of the above-mentioned drawbacks in the related art, it is an object of the present invention to provide a system that is satisfactorily adapted for desires of users even when a plurality of storage systems are distributed over a communication network.

To achieve the above object, there is provided a storage system connected to one or more other storage systems via a communication network, managing plural kinds of data, and receiving an access request for the data from an information processing terminal via the communication network, the storage system comprising a transmitting/-receiving unit for transmitting and receiving data; and a data transfer managing unit for transferring, through the transmitting/receiving unit, a part of the plural kinds of data, which satisfies a preset condition regarding a time-dependent factor, to another storage system specified by a destination-of-transfer candidate information sent from the information processing terminal.

To achieve the above object, there is also provided a program for operating a storage system that is connected to one or more other storage systems via a communication network, manages plural kinds of data, and receives an access request for the data from an information processing terminal via the communication network, the program instructing a computer to execute a transmitting/receiving step of transmitting and receiving data; and a data transfer managing step of transferring, in the transmitting/receiving step, a part of the plural kinds of data, which satisfies a preset condition regarding a time-dependent factor, to another storage system specified by a destination-of-transfer candidate information sent from the information processing terminal.

The preset condition may be set to a condition that frequency of the access request to data exceeds a preset value, the data being demanded by the access request from the information processing terminal and requested to be transferred to the aforesaid another storage system specified by the destination-of-transfer candidate information, or it may be set to a condition that the latest time of the access request to data demanded by the access request from the information processing terminal is past in excess of a preset time.

The program for operating the storage system may further instruct the computer to execute a destination-of-transfer candidate selecting step of selecting one of the aforesaid one or more other storage systems connected to the communication network, to which data is to be transferred from a storage system as an origin of transfer, in accordance with a preset condition. In that case, the preset condition used in the destination-of-transfer candidate selecting step for selecting the one of the aforesaid one or more other storage systems may be set to a condition that a response time between the selected storage system and the information processing terminal is minimum in a direct or indirect way, or it may be a service condition required for the storage system as a destination of transfer.

Moreover, transfer of data to the aforesaid another storage system in the transmitting/receiving step may be performed in the form of data movement in which the transferred data is not left in the storage system as an origin of transfer, or may be performed in the form of data copy in which the transferred data is left in the storage system as an origin of transfer. When the data transfer is performed in the form of data movement, the program preferably further instructs the computer to execute a data movement determining step of, upon receiving an access request for particular data from the information processing terminal, determining whether the particular data has been already moved, and upon determining that the particular data has been already moved, notifying the storage systems as a destination of movement to the information processing terminal in the transmitting/-receiving step or transferring the access request to the storage systems as a destination of movement in the transmitting/receiving step.

To achieve the above object, there is further provided a method for operating a storage system that is connected to one or more other storage systems via a communication network, manages plural kinds of data, and receives an access request for the data from an information processing terminal via the communication network, the method comprising a transmitting/receiving step of transmitting and receiving data; and a data transfer managing step of transferring, in the transmitting/receiving step, a part of the plural kinds of data, which satisfies a preset condition regarding a time-dependent factor, to another storage system specified by destination-of-transfer candidate information sent from the information processing terminal.

To achieve the above object, there is still further provided an information processing terminal for issuing, to any of a plurality of storage systems interconnected via a communication network, an access request for particular data via the communication network, the terminal comprising a destination-of-transfer candidate acquiring unit for searching the plurality of storage systems connected to the communication network, and selecting another one of the plurality of storage systems, to which data is to be transferred from one of the plurality of storage systems receiving the issued access request, in accordance with a preset condition; and a destination-of-transfer candidate information adding unit for adding destination-of-transfer candidate information indicative of the aforesaid another storage system, to which the data is to be transferred, to the access request issued to the one storage system.

To achieve the above object, there is still further provided a program for operating an information processing terminal that issues, to any of a plurality of storage systems interconnected via a communication network, an access request for particular data via the communication network, the program instructing a computer to execute a searching step of searching the plurality of storage systems connected to the communication network; a destination-of-transfer candidate selecting step of selecting, out of the plurality of storage systems searched in the searching step, another storage system to which data is to be transferred from one of the plurality of storage systems receiving the issued access request, in accordance with a preset condition; and a destination-of-transfer candidate information adding step of adding destination-of-transfer candidate information indicative of the aforesaid another storage system, to which the data is to be transferred, to the access request issued to the one storage system.

The preset condition used in the destination-of-transfer candidate selecting step for selecting the aforesaid another storage system, to which data is to be transferred from one of the plurality of storage systems receiving the issued access request, may be set to a condition that a response time between the selected storage system and the information processing terminal is minimum in a direct or indirect way, or it may be set to a service condition required for the storage system.

In addition, to achieve the above object, there is provided a data management system comprising the plurality of above-described storage systems and the above-described information processing terminal interconnected via a communication network.

With the present invention having the features set forth above, since the storage system as the origin of transfer automatically transfers data to one of other storage systems, which satisfies a desire of a user, the data management system is adaptable for desires of users without imposing a burden on the users. Practically, for example, when the response time between the information processing terminal and the storage system is to be taken into consideration, data is transferred to the storage system having a shorter response time. When a service condition such as a service charge is to be taken into consideration, data is transferred to the storage system providing service at a lower charge.

### BRIEF DESCRIPTION OF THE DRAWINGS

FIG. 1 is a block diagram for explaining an overall configuration of a data management system in a first embodiment according to the present invention;

FIG. 2 is a flowchart showing operation of a user terminal in the first embodiment according to the present invention;

FIG. 3 is a flowchart showing operation of the user terminal executed upon an input of an access request in the first embodiment according to the present invention;

FIG. 4 is a flowchart showing operation of an origin-of-movement storage system in the first embodiment according to the present invention;

FIG. 5 is a representation for explaining one practical example of the access request in the first embodiment according to the present invention;

FIG. 6 is a representation for explaining details of a destination-of-movement candidate management table in the first embodiment according to the present invention;

FIG. 7 is a representation for explaining details of a destination-of-movement management table in the first embodiment according to the present invention;

FIG. 8 is a flowchart showing operation of an origin-of copy storage system in a second embodiment according to the present invention;

FIG. 9 is a block diagram for explaining an overall configuration of a data management system in a third embodiment according to the present invention;

FIG. 10 is a block diagram for explaining an overall configuration of a data management system in a fourth embodiment according to the present invention;

FIG. 11 is a flowchart showing operation of an origin-of-movement storage system in the fourth embodiment according to the present invention;

FIG. 12 is a representation for explaining one practical example of the access request in the fourth embodiment according to the present invention; and

FIG. 13 is a block diagram for explaining an overall configuration of a data management system in a fifth embodiment according to the present invention.

### DESCRIPTION OF THE PREFERRED EMBODIMENTS

Several preferred embodiments of a data management system according to the present invention will be described below.

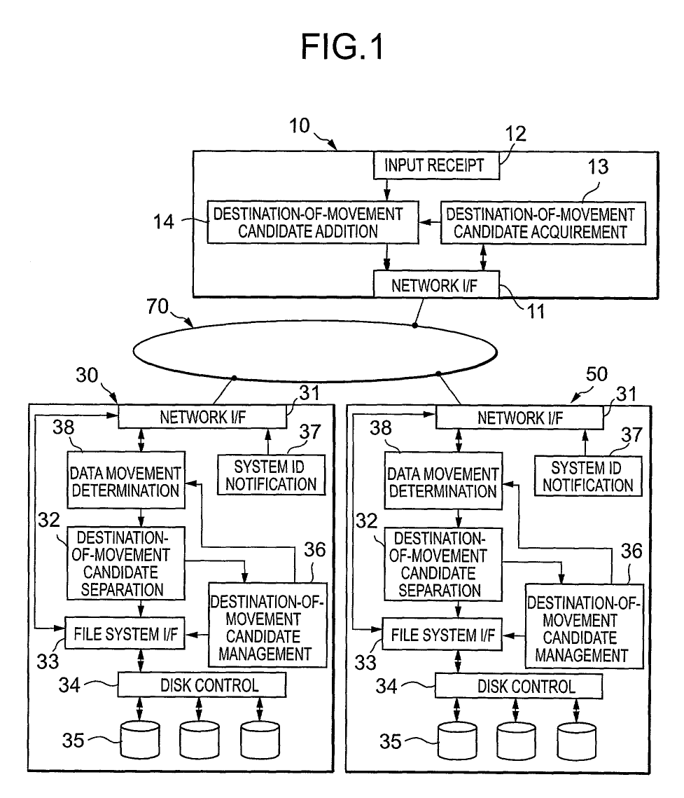

First, a description is made of a first embodiment of the data management system according to the present invention with reference to FIGS. 1 to 7.

The data management system according to the present invention is utilized by, e.g., salespeople who visit a plurality of customers for selling products. When salespeople visit a plurality of customers for selling products, it has been common that they carry paper-based materials, such as pamphlets, for an explanation of the products. Meanwhile, with the recent progress of IT (Information Technology), it has become possible for salespeople to explain products in a manner more easily understandable to customers using a notebook computer or the like carried with them, and to prepare materials for a new proposal on that spot, taking into account the customer's opinion. For enabling salespeople to more easily perform such sales business, there is a demand for a further reduction in weight of notebook computers or the likes carried with the salespeople. One conceivable solution of meeting the demand is to employ a mobile information processing terminal (referred to as a “user terminal” hereinafter) that is obtained by separating a storage from a notebook computer or the like carried with them, to acquire all of necessary data from a remote storage via a communication network, and to display or edit the acquired data.

However, if a substantial delay occurs in communication when trying to acquire data via the communication network as mentioned above, response is so deteriorated that the salespeople and the customers are both displeased. In view of such a situation, this embodiment is intended to minimize deterioration in response at the time of acquiring data via the communication network.

As shown in FIG. 1, the data management system of this embodiment comprises a user terminal 10 and a plurality of storage systems 30, 50 which are interconnected via a communication network 70. Note that, for convenience of the following description, one 30 of the plurality of storage systems 30, 50 is assumed to be an origin-of-movement storage system, and the other 50 is assumed to be a destination-of-movement storage system.

The user terminal 10, which is the so-called mobile information terminal as mentioned above, comprises a network interface 11, an input receiving unit 12 for receiving, e.g., an input from the user, a destination-of-movement candidate acquiring unit (destination-of-transfer candidate acquiring means) 13 for acquiring a candidate for the destination of movement of data possessed by the origin-of-movement storage system 30, and a destination-of-movement candidate adding unit (destination-of-transfer candidate information adding means) 14 for, when an access request is sent to the origin-of-movement storage system 30, adding information (IP address of the destination of movement) regarding the destination-of-movement candidate to the access request.

Each of the storage systems 30, 50 comprises a network interface 31 (transmitting/receiving means) that serves as an interface to the communication network 70, a destination-of-movement candidate separating unit 32 for separating the destination-of-movement candidate information from data of the access request transmitted from the user terminal 10, a file system interface 33, a disk control unit 34 for controlling the operation of a magnetic disk drive, a plurality of logical volumes 35, 35, . . . developed on a magnetic disk, a destination-of-movement candidate managing unit (data transfer managing means) 36 for managing the destination-of-movement candidate information provided from the destination-of-movement candidate separating unit 32, a system ID notifying unit 37 for notifying the ID of the system itself, e.g., the IP address of the system itself in this embodiment, in response to a request, and a data movement determining unit 38 for determining whether data requested by the access request from the user terminal 10 has been already moved. Those various units as components of the user terminal 10 and the storage systems 30, 50 are constructed in combination with a CPU and a memory as basic hardware components of the user terminal 10 and the storage systems 30, 50, and are operated to perform their functions with the CPU executing programs stored in the memory.

The destination-of-movement candidate managing unit 36 has a management table shown in FIG. 6. The management table is used to manage respective management numbers 91 of the logical volumes 35 possessed by the storage systems 30, 50, respective IP addresses as information of destination-of-transfer candidates 92 of the logical volumes, respective access counts 93 corresponding to both the logical volumes and the destination-of-movement candidates thereof, and time stamps 94 each indicating the date and time of update of table data. In an example shown in FIG. 6, for the logical volume having the management number “1”, IP addresses of “−”, “destaddr1” and “destaddr2” are assigned as those of the destination-of-movement candidates 92. These destination-of-movement candidates 92 are assigned with respective access ccounts 93 of “10”, “2” and “4”, and with respective latest time stamps 94 of “Dec. 18, 2001 11:00:00”, “Dec. 19, 2001 12:00:00” and “Dec. 21, 2001 13:30:30”. Incidentally, the IP address “−” of the destination-of-movement candidate means that an access request is received from the user terminal 10, but no destination-of-movement candidate information is added to the received access request.

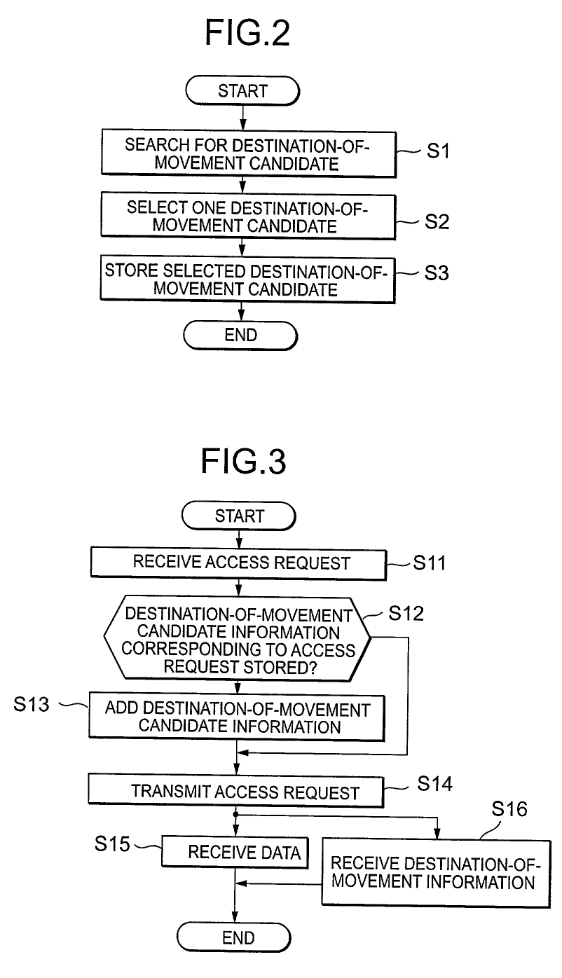

The operation of the user terminal 10 will be described below with reference to a flowchart shown in FIG. 2.

The destination-of-movement candidate acquiring unit 13 of the user terminal 10 first searches for candidates of available storage systems by broadcasting an inquiry to an indefinite number of storage systems via the communication network 70 (step 1). On that occasion, at the same time as broadcasting the inquiry, a timer is started up to count a time until a response to the inquiry is received from each candidate. When one or more responses from the system ID notifying units 37 of the plurality of storage systems are received, IP addresses contained in the received responses are temporarily stored. Subsequently, the destination-of-movement candidate acquiring unit 13 selects an optimum one storage system 50 for usage from among one or more storage systems having issued the responses (step 2). In the selecting step, the storage system corresponding to the shortest one of the response times counted in step 1 is selected. It is here assumed that the available storage system 50 existing in the district nearest to the user terminal 10 is selected. Then, the destination-of-movement candidate acquiring unit 13 passes the IP address of the selected destination-of-movement storage system 50 to the destination-of-movement candidate adding unit 14. The destination-of-movement candidate adding unit 14 holds that IP address until the destination-of-movement candidate is changed (step 3).

The above-described process is executed upon a trigger given by, e.g., receipt of the access request (described later) or connection of the user terminal 10 to the communication network 70.

The operation of the user terminal 10 executed when the user refers to data in the storage system will be described below with reference to a flowchart shown in FIG. 3.

When the user terminal 10 receives an input of an access request to the origin-of-movement storage system 30 from the user (step 11), the destination-of-movement candidate adding unit 14 determines whether the destination-of-movement candidate information corresponding to the access request is stored (step 12). If stored, the IP address, i.e., the stored destination-of-movement candidate information, is added to the access request (step 13), and resultant data is transmitted to the origin-of-movement storage system 30 via the network interface 11 and the communication network 70 (step 14). If the destination-of-movement candidate information is not stored in step 12, the access request data is transmitted, as it is, to the origin-of-movement storage system 30 (step 14).

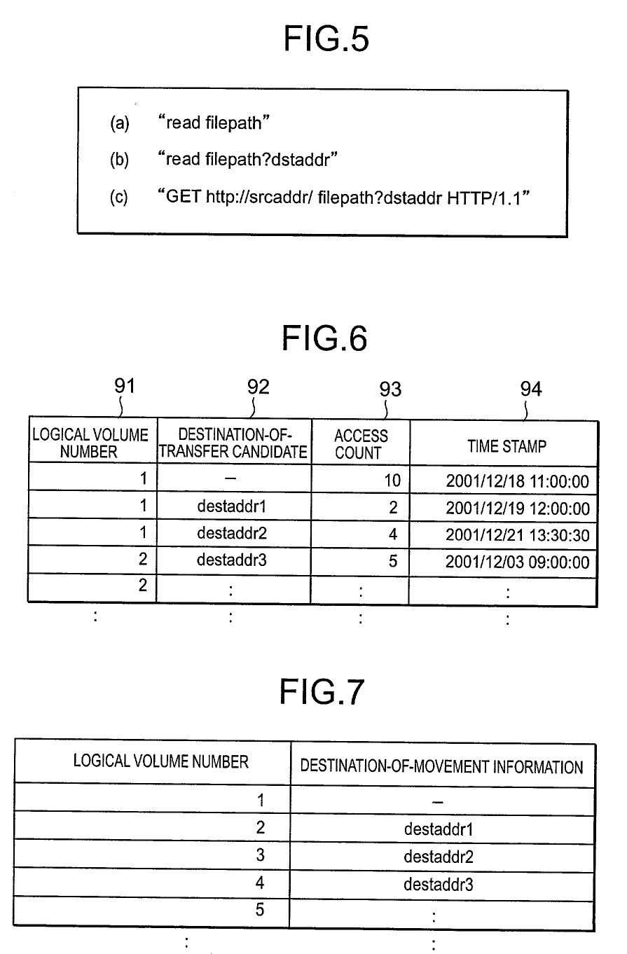

A description is now be made of a practical example of the access request with reference to FIG. 5. In this example, information shown at (a) in FIG. 5 represents the access request implying a read request to data indicated by “filepath”. Also, information shown at (b) in FIG. 5 represents the access request implying a read request to data indicated by “filepath”, and the destination-of-movement candidate information for data indicated by an IP address “dstaddr”. Further, information shown at (c) in FIG. 5 represents essentially the same contents as those of the information shown at (b), but is described in the request form according to HTTP (Hypertext Transfer Protocol) 1.1. Incidentally, “srcaddr” represents an IP address of the origin of movement.

If the origin-of-movement storage system 30 having received the access request possesses data corresponding to the access request, the corresponding data is transmitted, and if it does not possess the corresponding data, the destination-of-movement information for the data is transmitted. Thus, after transmitting the access request (step 14), the user terminal 10 receives the corresponding data from the origin-of-movement storage system 30 (step 15) or the destination-of-movement information for the corresponding data from the origin-of-movement storage system 30 (step 16). In the latter case, after receiving the destination-of-movement information (IP address) for the corresponding data, the user newly issues the access request to the storage system 50 designated by the received destination-of-movement information.

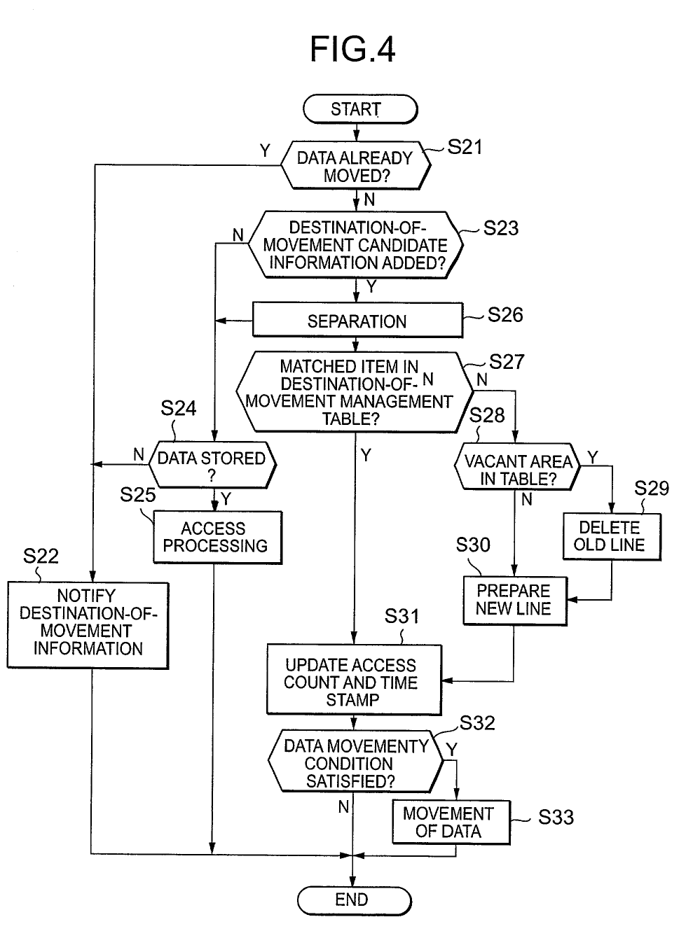

The operation of the origin-of-movement storage system 30 executed upon receiving an access request from the user terminal 10 will be described below with reference to a flowchart shown in FIG. 4.

When the data movement determining unit 38 of the origin-of-movement storage system 30 receives an access request from the user terminal 10, it determines whether the data corresponding to the access request has been already moved (step 21). The data movement determining unit 38 has a table storing therein, as shown in FIG. 7, the ID (logical volume number) of the data having been moved before and the destination-of-movement information (IP address) for the moved data, both of which are received from the destination-of-movement candidate managing unit 36. The above determination is made with reference to the table. If the data movement determining unit 38 determines that the data corresponding to the access request has been already moved, the destination-of-movement information (IP address) is notified to the user terminal 10 via the network interface 31 and the communication network 70 (step 22). On the other hand, if it is determined in step 21 that the data corresponding to the access request is not yet moved, the destination-of-movement candidate separating unit 32 determines whether the destination-of-movement candidate information is added to the access request (step 23). If the destination-of-movement candidate information is not added to the access request, the access request is passed, as it is, to the file system interface 33. The file system interface 33 determines whether the data corresponding to the access request is stored (step 24). If it is determined that the corresponding data is stored, processing to access that data is executed (step 25). If it is determined in step 24 that the corresponding data is not stored, the ID of that data is passed to the data movement determining unit 38, and the determination result is notified to the user terminal 10. More specifically, the data movement determining unit 38 determines whether the data indicated by the data ID has been already moved, and if already moved, information of the destination of the movement is notified to the user terminal 10. If the data indicated by the data ID is not yet moved, this means that the indicated data has not been stored in the past. In that case, therefore, the user terminal 10 is just notified of the fact that the data is not present.

If it is determined in step 23 that the destination-of-movement candidate information is added to the access request, the destination-of-movement candidate separating unit 32 separates the access request and the destination-of-movement candidate information from each other, and then passes the access request to the file system interface 33 and the destination-of-movement candidate information to the destination-of-movement candidate managing unit 36 (step 26). The file system interface 33 having received the access request executes the above-described processing of steps 24 and 25. The destination-of-movement candidate managing unit 36 having received the destination-of-movement candidate information executes processing of subsequent steps 27 to 33.

Upon receiving the destination-of-movement candidate information, the destination-of-movement candidate managing unit 36 refers to the management table shown in FIG. 6 and determines whether there is an item matched with the particulars indicated by the destination-of-movement candidate information (step 27). If there is a matched item, the access count and the time stamp of the item are updated (step 31). If there is no matched item, it is determined whether the management table has a vacant area (step 28). If there is a vacant area at that time, a new line is prepared and both the logical volume number and the destination-of-movement candidate information for the data corresponding to the access request are stored in the line (step 30). If there is not vacant area, one old line is deleted (step 29) and thereafter a new line is prepared in the same manner as described above (step 30). After preparing the new line (step 30), the access count and the time stamp of the item are described in the new line (step 31).

After updating the access count and the time stamp in the management table (step 31), the destination-of-movement candidate managing unit 36 determines whether, among the logical volume numbers in the management table, there is one satisfying a preset data movement condition (step 32). In this embodiment, one of the logical volume numbers in the management table, which has the access count 93 not lower than a preset value, is determined as satisfying the data movement condition. If there is no logical volume number satisfying the data movement condition, the process flow is brought into an end. If there is a logical volume number satisfying data movement condition, data corresponding to the logical volume number that satisfies the data movement condition is read by the disk control unit 34 and then moved to the candidate for the destination of movement via the network interface 31 (step 33).

Herein, when using the Internet as the communication network for the date movement, protocols over TCP/IP, such as FTP and HTTP, are employed. Also, when using a SAN (Storage Area Network) as the communication network for the date movement, the dedicated transfer system is employed. The SAN is explained in detail in “Nikkei Electronics”, pp. 58-63, issued May 4, 1998.

After receiving the data, the destination-of-movement storage system 50 becomes an origin-of-movement storage system for that data and executes the operation in a similar manner as described above.

Thus, in this embodiment, when the user terminal 10 demands particular data to be moved to the storage system 50 having the shortest response time in excess of predetermined times, the particular data is moved to the storage system 50. After the data movement, therefore, the response time can be reduced by accessing the destination-of-movement storage system 50 to which the particular data has been moved.

In the embodiment described above, when the data corresponding to the access request has been already moved, the data movement determining unit 38 of the origin-of-movement storage system 30 notifies the destination-of-movement information to the user terminal 10 (step 22 in FIG. 4). As an alternative, the access request from the user terminal 10 may be transferred to the storage system indicated by the destination-of-movement information. Also, when the data corresponding to the access request has been already moved, the destination of movement may be searched for, instead of notifying the destination-of-movement information or transferring the access request to the destination of movement as described above, by selecting several of the candidates for the destination of movement on the user terminal 10 side and transmitting the access request to each of the selected candidates. Alternatively, the destination of movement may be searched for by inquiring, from the user terminal 10 side to a plurality of other user terminals, the destination-of-movement candidate information held by the destination-of-movement candidate adding unit 14 in each of the other user terminals, and then transmitting the access request to each of the destinations of movement indicated by the destination-of-movement candidate information obtained from the plurality of other user terminals.

Also, in the above description, when an access request is received and the destination-of-movement candidate managing unit 36 of the origin-of-movement storage system 30 updates the access count and the time stamp (step 31), whether the data movement condition is satisfied is determined at once (step 32). However, the destination-of-movement candidate managing unit 36 may execute that determination independently of the receipt of the access request, such as executing the determination at intervals of a certain time, for example.

Further, while the user terminal 10 in this embodiment selects, as the candidate for the destination of movement, the storage system having the shortest response time, the storage system that exists in an area nearest to the actual position of the user terminal 10 may be regarded as the one having the shortest response time and selected as the candidate for the destination of movement. In that case, it is required that the geometrical position of the user terminal 10 is inputted to the user terminal 10, and the respective geometrical positions of a plurality of storage systems are transmitted along with the IP addresses thereof from the plurality of storage systems to the user terminal 10. Also, when the storage system geometrically nearest to the user terminal 10 is selected, a modification may be made such that the position of the user terminal 10 is sent from the user terminal 10 to the origin-of-movement storage system 30 along with the access request, and the origin-of-movement storage system 30 inquires a plurality of storage systems about the geometrical positions thereof and then selects the storage system nearest to the user terminal 10. Further, in that case, instead of inquiring the geometrical positions of the storage systems, the origin-of-movement storage system 30 may register the geometrical positions of each storage system beforehand and select one of the storage systems nearest to the user terminal 10. Incidentally, GPS receiving apparatus may be provided to the user terminal 10 and storage systems 30, 50 so as to enable each apparatus 10, 30 and 50 acquire the geometrical position of themselves automatically.

Moreover, while the above description has been made, as one form of data transfer, in connection with movement of data in which no data remains at the origin of transfer after transferring the data, the present invention is not limited to such an example, and the data transfer may be performed as copy of data in which data remains at the origin of transfer after transferring the data.

Therefore, the following description is made of a second embodiment of the data management system in which data is copied from one storage system to another.

The functional configuration of a storage system according to this second embodiment is basically the same as that of the above-described storage system according to the first embodiment except that the data movement determining unit 38 is replaced by a data copy determining unit, the destination-of-movement candidate separating unit 32 is replaced by a destination-of-copy candidate separating unit, and the destination-of-movement candidate managing unit 36 is replaced by a destination-of-copy candidate managing unit.

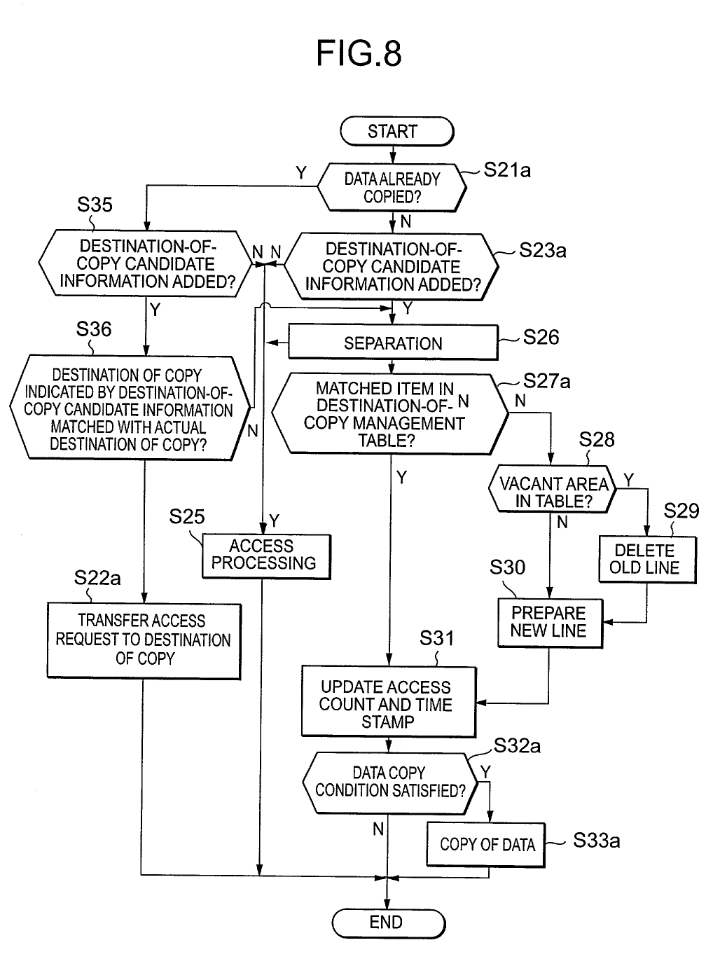

An origin-of-copy storage system in this embodiment operates as shown in a flowchart of FIG. 8 upon receiving an access request from the user terminal.

When the data copy determining unit receives an access request from the user terminal 10, it determines whether data corresponding to the access request has been already copied (step 21a ). As with the first embodiment described above, the data copy determining unit receives and stores the ID of the copy data and the destination-of-copy information (IP address) thereof from the destination-of-copy candidate managing unit, and makes that determination based on the stored information. When the data copy determining unit determines that the data corresponding to the access request is not yet copied, processing of steps 23a, 26, 27a, 28, 29, 30, 31, 32a and 33a is executed in a similar manner as that in the first embodiment described above. On the other hand, if the data copy determining unit determines that the data corresponding to the access request has been already copied, the destination-of-copy candidate separating unit determines whether the destination-of-copy candidate information is added to the access request (step 35). If the destination-of-copy candidate information is not added to the access request, the access request is passed, as it is, to the file system interface and processing to access the corresponding data is executed (step 25). If it is determined in step 35 that the destination-of-copy candidate information is added to the access request, the data copy determining unit determines whether the destination of copy indicated by the destination-of-copy candidate information is matched with the actual destination of copy (step 36). If the destination of copy indicated by the destination-of-copy candidate information is matched with the actual destination of copy, the access request is transferred to the actual destination of copy (step 22a). If not matched, the destination-of-copy candidate separating unit separates the access request and the destination-of-copy candidate information from each other (step 26). The separated access request is passed to the file system interface and then subjected to the processing to access the data (step 25). The separated destination-of-copy candidate information is passed to the destination-of-copy candidate managing unit and then subjected to the processing of steps 27a to 33a.

Thus, in this embodiment, when the data corresponding to the access request has been already copied, the access request is transferred to the destination of copy (step 22a) if the destination-of-copy candidate information added to the access request is matched with the actual destination of copy (step 36), but the access processing (step 25) and the destination-of-copy candidate management processing (steps 27a to 33a) are executed if otherwise, e.g., even if the data corresponding to the access request has been already copied. In this embodiment, therefore, even when the data corresponding to the access request has been already copied, the corresponding access account and time stamp are updated (step 31) unlike the first embodiment. This is because this second embodiment differs from the first embodiment in that the origin-of-copy storage system stores data even after copying of the data, and continues to function as the origin of copy.

While in this second embodiment the access request is transferred to the destination of copy in step 22a, the destination-of-copy information may be notified to the user terminal as with the first embodiment. Also, when the data corresponding to the access request has been already copied, it may be made essential to transfer the access request to the destination of copy or notify the destination-of-copy information to the user terminal.

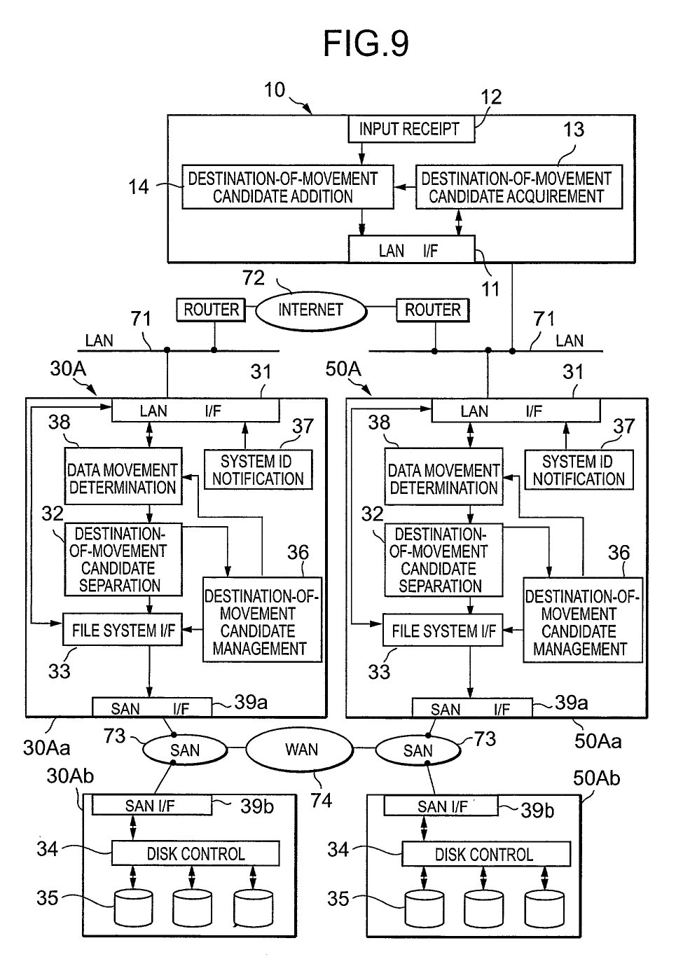

A third embodiment of the data management system according to the present invention will be described below with reference to FIG. 9.

Storage systems 30A, 50A in this third embodiment are constructed by separating the respective storage systems in the first embodiment into host computers 30Aa, 50Aa and storage devices 30Ab, 50Ab and connecting each pair of the host computer and the storage device via a SAN (Storage Area Network) 73. The SAN 73 on the origin-of-movement storage system 30A side and the SAN 73 on the destination-of-movement storage system 50A side are interconnected via a WAN (Wide Area Network) 74. Also, the user terminal 10 is connected to the host computers 30Aa, 50Aa of the storage systems 30A, 50A via a LAN (Local Area Network) 71 and the Internet 72.

Each of the host computers 30Aa, 50Aa comprises a LAN interface 31, a destination-of-movement candidate separating unit 32, a file system interface 33, a destination-of-movement candidate managing unit 36, a system ID notifying unit 37, and a SAN interface 39a. Also, each of the storage devices 30Ab, 50Ab comprises a disk control unit 34, a plurality of logical volumes 35, 35, . . . developed on a magnetic disk, and a SAN interface 39b. Data is received and transmitted between the file system interfaces 33 of the host computers 30Aa, 50Aa and the disk control units 34 of the storage devices 30Ab, 50Ab via the SAN interfaces 39a, 39b and the SAN's 73.

With the above-described configuration that the storage systems are divided into the host computers 30Aa, 50Aa and the storage devices 30Ab, 50Ab which are interconnected via the SAN 73, similar advantages to those in the first embodiment can be basically obtained. While each the storage devices 30Ab, 50Ab in this embodiment comprises the disk control unit 34 and the logical volume 35 that are components of the storage system in the first embodiment, each storage device may further comprise a destination-of-movement candidate managing unit 36. In that case, the destination-of-movement candidate managing unit 36 of the storage device is preferably communicated with the destination-of-movement candidate separating unit 32, the file system interface 33, etc. via the LAN interfaces.

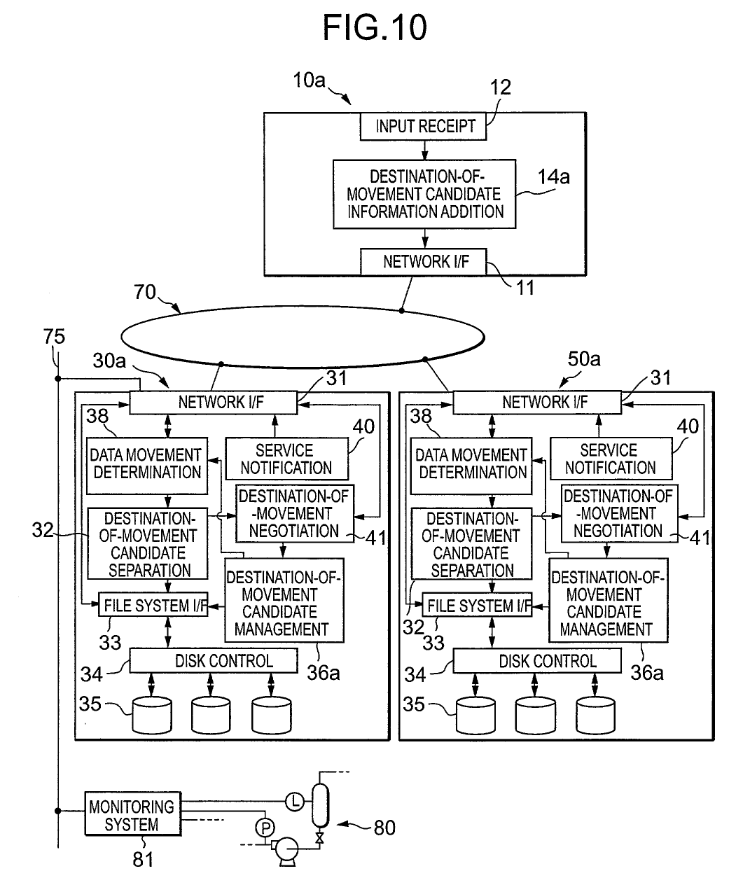

A fourth embodiment of the data management system according to the present invention will be described below with reference to FIGS. 10 to 12.

In a system for monitoring a control system in a plant or the like, monitoring data of objects to be monitored, i.e., apparatuses and parts in the plant, is collected at certain time intervals and stored in a database. A facility supervisor performs management of the facility operation by referring to the monitoring data collected at certain time intervals and stored in the database. In such a case, because the past monitoring data remains in the database indefinitely, it is required to periodically perform work of backing up the data in the database to another medium and deleting the original monitoring data. As one conceivable solution of cutting down the management cost for a backup medium, the backup work is subcontracted to a BSP (Backup Service Provider).

For minimizing the cost required for backup of the monitoring data, setting must be made such that the monitoring data is backed up in a storage system which can be utilized at cost as low as possible. However, when a service level (such as a service charge) of each storage system is frequently changed, it is difficult to manually alter the setting each time the service level is changed. In view of the above, this embodiment is intended to automatically select the destination of backup depending on a service level designated by the user so that the burden imposed on the user is reduced.

As shown in FIG. 10, a data management system of this embodiment comprises a user terminal 10a and a plurality of storage systems 30a, 50a which are interconnected via a communication network 70, as with the above-described embodiments.

The user terminal 10a comprises a network interface 11, an input receiving unit 12 for receiving, e.g., an input from the user, and a destination-of-movement candidate information adding unit 14a for, when an access request is sent to the origin-of-movement storage system 30a, adding destination-of-movement candidate information (service condition required for the destination of movement) to the access request.

Each of the storage systems 30a, 50a comprises, as with the first embodiment, a network interface 31, a destination-of-movement candidate information separating unit 32, a file system interface 33, a disk control unit 34, a plurality of logical volumes 35, 35, . . . , and a destination-of-movement candidate managing unit 36a. Further, each of the storage systems 30a, 50a comprises a service notifying unit 40 for notifying details of service provided by the system itself in response to an external request, and a destination-of-movement negotiating unit 41 for negotiating with another storage system and deciding a candidate for the destination of movement.

The origin-of-movement storage system 30a is connected to a plant monitoring system 81 via a communication network 75. Signals, etc. are inputted to the monitoring system 81 from various instruments and so on that are a provided in a plant facility 80. Plant monitoring data acquired by the monitoring system 81 is periodically sent to the origin-of-movement storage system 30a. The file system interface 33 of the origin-of-movement storage system 30a stores plant monitoring data received by the network interface 31 in the logical volume 35 successively.

The operation of the user terminal 10a will be described below.

The input receiving unit 12 of the user terminal 10a receives destination-of-movement candidate information and passes the received information to the destination-of-movement candidate information adding unit 14a to be stored therein. The destination-of-movement candidate information is information regarding a destination-of-movement candidate selecting condition; for example, “the destination of movement in which data is to be stored is a storage system providing service at a charge within 2000 yen per month”. Other examples of the destination-of-movement candidate information include “a storage system allowing access to the plant monitoring data as late as 1:00 AM to 3:00 AM” and “a storage system enabling users to receive a particular associated service”.

When the user demands access to the plant monitoring data, the user terminal 10a executes, as shown in the flowchart of FIG. 3 described above in connection with the first embodiment, successive processes of receiving the access request (step 11), determining whether the destination-of-movement candidate information is stored (step 12), adding the destination-of-movement candidate information to the access request (step 13), transmitting the access request to the origin-of-movement storage system 30a (step 14), and receiving the relevant data (step 15) or receiving the destination-of-movement candidate information (step 16).

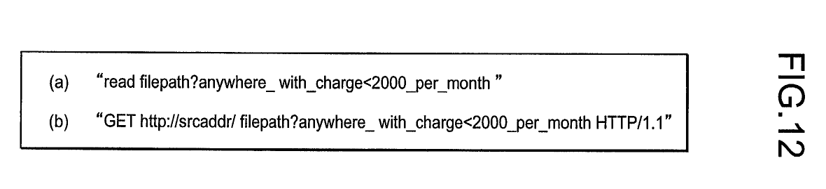

A description is now be made of a practical example of the access request with reference to FIG. 12. In this example, information shown at (a) in FIG. 12 represents the access request implying a read request to data indicated by “filepath”, and the destination-of-movement candidate information implying “the destination of movement in which data is to be stored is a storage system providing service at a charge within 2000 yen per month”. Also, information shown at (b) in FIG. 12 represents essentially the same contents as those of the information shown at (b), but is described in the request form according to HTTP 1.1.

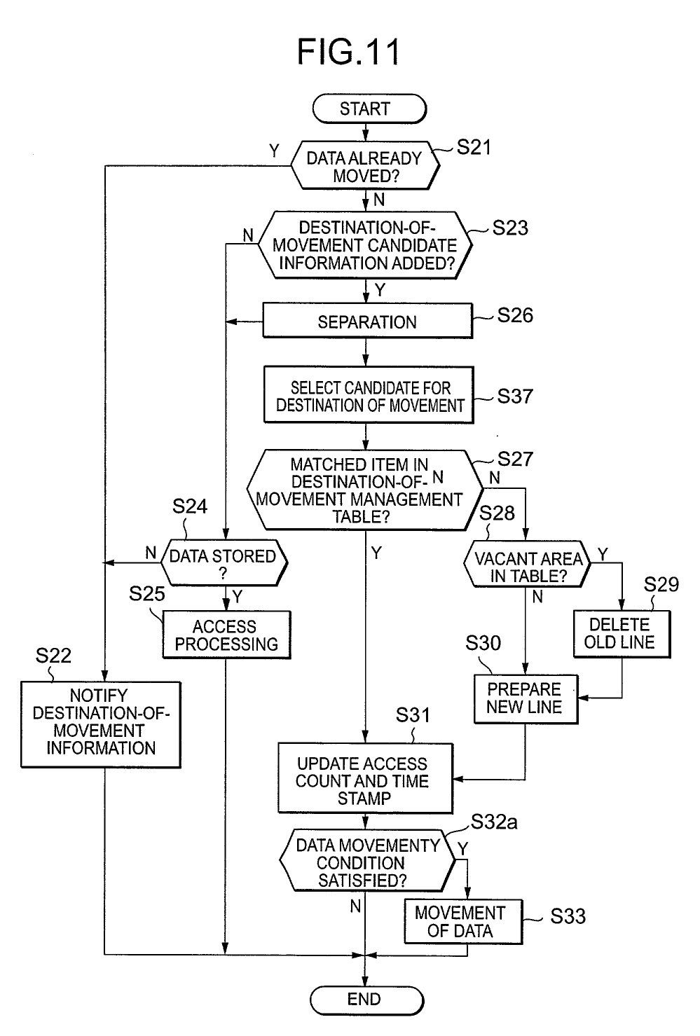

The operation of the origin-of-movement storage system 30a executed upon receiving an access request from the user terminal 10a will be described below with reference to a flowchart shown in FIG. 11.

When the origin-of-movement storage system 30a receives an access request from the user terminal 10a, it executes, as with the first embodiment, successive processes of determining whether data corresponding to the access request has been already moved (step 21), notifying the destination of movement if the corresponding data has been already moved (step 22), determining whether the destination-of-movement candidate information is added (step 23), determining whether the data corresponding to the access request is stored (step 24), making access to the data if the data corresponding to the access request is stored (step 25), and separating the access request and the destination-of-movement candidate information from each other if the destination-of-movement candidate information is added (step 26).

The access request separated in step 26 is, as with the first embodiment, passed to the file system interface 33 and then subjected to the processing of step 24. On the other hand, the destination-of-movement candidate information separated in step 26 is passed to the destination-of-movement negotiating unit 41 and then subjected to the processing of step 37 described below.

If the destination-of-movement negotiating unit 41 recognizes that the passed destination-of-movement candidate information implies “the destination of movement in which data is to be stored is a storage system providing service at a charge within 2000 yen per month”, it issues an inquiry of charge schedules to a plurality of previously registered storage systems via the network interface 31 and the communication network 70. The service notifying unit 40 of each storage system having received the inquiry transmits the charge schedule of that storage system to the destination-of-movement negotiating unit 41 of the origin-of-movement storage system 30a. Then, the destination-of-movement negotiating unit 41 selects, as a candidate for the destination of movement, one of the storage systems, of which charge schedule satisfies the selecting condition indicated by the destination-of-movement candidate information, and then passes information of the selected candidate for the destination of movement to the destination-of-movement candidate managing unit 36a (step 37). When there are a plurality of candidates for the destination of movement satisfying the selecting condition, e.g., when there are two storage systems providing service at charges of 1800 yen and 1700 yen that satisfy the selecting condition, the storage system providing service at a charge of 1700 yen is selected. While, in this embodiment, the destination-of-movement negotiating unit 41 of the origin-of-movement storage system 30a issues an inquiry of charge schedules to the other storage systems based on the destination-of-movement candidate information, the information including the destination-of-movement candidate information may be transmitted, as it is, to the destination-of-movement negotiating unit 41 in each of the other storage systems. In that case, the destination-of-movement negotiating unit 41 in each of the other storage systems is instructed to determine whether the charge schedule of its own system satisfies the selecting condition indicated by the destination-of-movement information transmitted from the origin-of-movement storage system 30a, and to send a reply indicating satisfaction of the selecting condition to the destination-of-movement negotiating unit 41 of the origin-of-movement storage system 30a only when the selecting condition is satisfied.

When destination-of-movement candidate managing unit 36a receives the information of the candidate for the destination of movement selected in step 37, processing of steps 28 to 33 is executed in a similar manner as that in the first embodiment. In this fourth embodiment, however, when the destination-of-movement candidate managing unit 36a determines in step 32a whether the data moving condition is satisfied, it refers to the management table shown in FIG. 6 and determines that the data moving condition is satisfied when a difference between the update time indicated by the time stamp 94 and the current time for each of the logical volume numbers is not less than a preset period of time. In other words, the logical volume that has not been accessed for a long period of time is determined as satisfying the data moving condition.

Thus, with this embodiment, the data management system is adaptable for a service level demanded by users without imposing a burden on the users.

While this embodiment has been described as providing the destination-of-movement negotiating unit 41 in each of the storage systems 30a, 50a, the destination-of-movement negotiating unit 41 may be provided in the user terminal 10a so that the destination-of-movement storage system is selected on the user terminal 10a side.

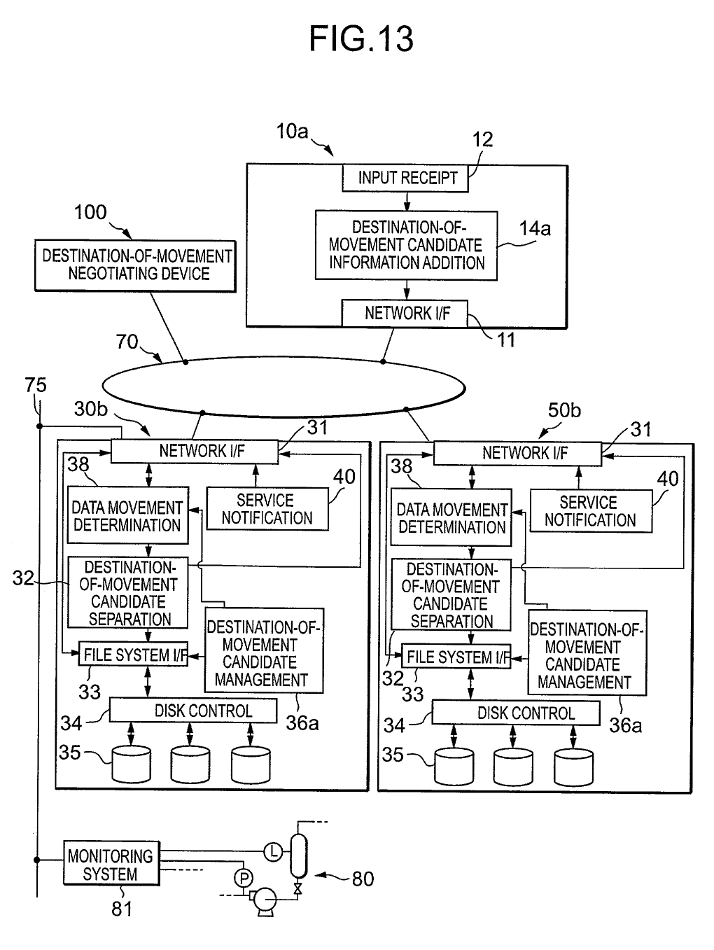

Also, while this embodiment has been described as providing the destination-of-movement negotiating unit 41 in each of the storage systems 30b, 50b, the destination-of-movement negotiating unit may be separated from each of the storage systems 30a, 50a and provided as a destination-of-movement negotiating device 100, i.e., a single intensive unit, on the communication network 70, as shown in FIG. 13.

In that case, when the destination-of-movement candidate information separating unit 32 of an origin-of-movement storage system 30b separates the destination-of-movement candidate information as with the fourth embodiment, the separated destination-of-movement candidate information is sent to the destination-of-movement negotiating device 100 via the network interface 31 and the communication network 70. As with the destination-of-movement negotiating unit 41 in the fourth embodiment, if the destination-of-movement negotiating device 100 recognizes that the passed destination-of-movement candidate information implies “the destination of movement in which data is to be stored is a storage system providing service at a charge within 2000 yen per month”, it issues an inquiry of charge schedules to a plurality of previously registered storage systems via the communication network 70. Then, the destination-of-movement negotiating device 100 receives information regarding respective charge schedules from the service notifying units 40 of each storage systems, decides a candidate for the destination of movement based on the received information regarding the charge schedules, and passes the decided candidate to the destination-of-movement candidate managing unit 36a of the origin-of-movement storage system 30b.

What is claimed is:

1. A storage system connected to one or more other storage systems via a communication network, managing plural kinds of data, and receiving an access request for the data from an information processing terminal via said communication network, said storage system comprising:
transmitting/receiving means for transmitting and receiving data; and
data transfer managing means for transferring, through said transmitting/receiving means, a part of the plural kinds of data, which satisfies a preset condition regarding a time-dependent factor, to another storage system specified by a destination-of-transfer candidate information sent from said information processing terminal.

2. A program for operating a storage system that is connected to one or more other storage systems via a communication network, manages plural kinds of data, and receives an access request for the data from an information processing terminal via said communication network, said program instructing a computer to execute the steps of:
a transmitting/receiving step of transmitting and receiving data; and
a data transfer managing step of transferring, in said transmitting/receiving step, a part of the plural kinds of data, which satisfies a preset condition regarding a time-dependent factor, to another storage system specified by a destination-of-transfer candidate information sent from said information processing terminal.

3. A program for operating a storage system according to claim 2, wherein said preset condition is set to a condition that frequency of the access request to data exceeds a preset value, the data being demanded by the access request from said information processing terminal and requested to be transferred to said another storage system specified by said destination-of-transfer candidate information, and
in said data transfer managing step, frequency of the access request is measured for each of the plural kinds of data, and data requested to be transferred to said another storage system specified by said destination-of-transfer candidate information and having the frequency of the access request in excess of said preset value is transferred to said another storage system in said transmitting/receiving step.

4. A program for operating a storage system according to claim 2, wherein said preset condition is set to a condition that the latest time of the access request to data demanded by the access request from said information processing terminal is past in excess of a preset time, and
in said data transfer managing step, the latest time of the access request is measured for each of the plural kinds of data, and data for which the latest time of the access request is past in excess of said preset time is transferred to said another storage system in said transmitting/receiving step.

5. A program for operating a storage system according to claim 2, wherein the program further instructs the computer to execute:
a destination-of-transfer candidate selecting step of selecting one of said one or more other storage systems connected to said communication network, to which data is to be transferred from a storage system as an origin of transfer, in accordance with a preset condition.

6. A program for operating a storage system according to claim 5, wherein said preset condition used in said destination-of-transfer candidate selecting step for selecting the one of said one or more other storage systems is set to a condition that a response time between the selected storage system and said information processing terminal is minimum in a direct or indirect way.

7. A program for operating a storage system according to claim 5, wherein said preset condition used in said destination-of-transfer candidate selecting step for selecting the one of said one or more other storage systems is a service condition required of the storage system as a destination of transfer.

8. A program for operating a storage system according to claim 2, wherein transfer of data to said another storage system in said transmitting/receiving step is performed in the form of data movement in which the transferred data is not left in the storage system as an origin of transfer.

9. A program for operating a storage system according to claim 8, wherein the program further instructs the computer to execute:
a data movement determining step of, upon receiving an access request for particular data from said information processing terminal, determining whether said particular data has been already moved, and upon determining that said particular data has been already moved, notifying the storage systems as a destination of movement to said information processing terminal in said transmitting/-receiving step or transferring said access request to the storage systems as a destination of movement in said transmitting/receiving step.

10. A method for operating a storage system that is connected to one or more other storage systems via a communication network, manages plural kinds of data, and receives an access request for the data from an information processing terminal via said communication network, said method comprising the steps of:
a transmitting/receiving step of transmitting and receiving data; and
a data transfer managing step of transferring, in said transmitting/receiving step, a part of the plural kinds of data, which satisfies a preset condition regarding a time-dependent factor, to another storage system specified by destination-of-transfer candidate information sent from said information processing terminal.

11. An information processing terminal for issuing, to any of a plurality of storage systems interconnected via a communication network, an access request for particular data via said communication network, said terminal comprising:
destination-of-transfer candidate acquiring means for searching said plurality of storage systems connected to said communication network, and selecting another one of said plurality of storage systems, to which data is to be transferred from one of said plurality of storage systems receiving the issued access request, in accordance with a preset condition; and
destination-of-transfer candidate information adding means for adding destination-of-transfer candidate information indicative of said another storage system, to which the data is to be transferred, to the access request issued to said one storage system.

12. A program for operating an information processing terminal that issues, to any of a plurality of storage systems interconnected via a communication network, an access request for particular data via said communication network, said program instructing a computer to execute the steps of:
a searching step of searching said plurality of storage systems connected to said communication network;
a destination-of-transfer candidate selecting step of selecting, out of said plurality of storage systems searched in said searching step, another storage system to which data is to be transferred from one of said plurality of storage systems receiving the issued access request, in accordance with a preset condition; and
a destination-of-transfer candidate information adding step of adding destination-of-transfer candidate information indicative of said another storage system, to which the data is to be transferred, to the access request issued to said one storage system.

13. A program for operating an information processing terminal according to claim 12, wherein said preset condition used in said destination-of-transfer candidate selecting step for selecting said another storage system, to which data is to be transferred from one of said plurality of storage systems receiving the issued access request, is set to a condition that a response time between the selected storage system and said information processing terminal is minimum in a direct or indirect way.

14. A program for operating an information processing terminal according to claim 12, wherein said preset condition used in said destination-of-transfer candidate selecting step for selecting said one another storage system to which data is to be transferred from one of said one or more storage systems receiving the issued access request is set to a service condition required of the storage system to which data is to be transferred.

15. A data management system comprising a plurality of storage systems and an information processing terminal interconnected via a communication network,
said information processing terminal comprising:
destination-of-transfer candidate information adding means for, upon receiving an access request for particular data, adding destination-of-transfer candidate information specifying a storage system, to which the particular data is to be transferred, to said access request, and sending said destination-of-transfer candidate information to one of said plurality of storage systems along with said access request,
said one storage system comprising:
transmitting/receiving means for transmitting and receiving data, and data transfer managing means for transferring, through said transmitting/receiving means, a part of plural kinds of data under management of said one storage system, which satisfies a preset condition regarding a time-dependent factor, to another storage system specified by said destination-of-transfer candidate information.

16. A data management system according to claim 15, further comprising:
a destination-of-data-transfer negotiating device connected to at least said one storage system via said communication network, receiving said destination-of-transfer candidate information from said one storage system, selecting said another storage system out of said plurality of storage systems in accordance with said destination-of-transfer candidate information, and transmitting information indicative of said another storage system to said data transfer managing means of said one storage system via said communication network.
